(19) United States
(12) Patent Application Publication
(10) Pub. No.: US 2009/0113400 A1
(43) Pub. Date: Apr. 30, 2009

(54) Device, System and method of Profiling Computer Programs

(76) Inventors: Dan Pelleg, Haifa (IL); Shmuel Ur, Shorashim (IL)

Correspondence Address: IBM CORPORATION, T.J. WATSON RESEARCH CENTER, P.O. BOX 218, YORKTOWN HEIGHTS, NY, 10598, US

(21) Appl. No.: 11/877,694

(22) Filed: Oct. 24, 2007

(51) Int. Cl. G06F 9/44

(52) U.S. Cl. 717/130

(57) ABSTRACT

Device, system, and method of profiling computer programs. For example, a method for profiling computer programs includes: profiling a program statement associated with a machine-readable comment indicating an expectation by a programmer of a runtime behavior of the program statement.

### FIELD

Some embodiments of the invention are related to the field of computer programming, and more particularly to profiling of computer programs.

### BACKGROUND

A programmer may write a computer program intended to be used by persons other than the programmer. During the programming process, the programmer may not know how exactly the computer program will be used by these users. The programmer may have expectations or assumptions regarding the future usage of the computer program by the users, but such expectations or assumptions may be wrong. Unfortunately, as a result of incorrect programmer's expectations or assumptions, the computer program may fail to operate, may operate inefficiently, may have functional defects, or may suffer from other performance issues.

### SUMMARY

Some embodiments of the invention include, for example, devices, systems, and methods of profiling computer programs.

In some embodiments, a method for profiling computer programs includes: profiling a program statement associated with a machine-readable comment indicating an expectation by a programmer of a runtime behavior of the program statement.

In some embodiments, the profiling includes: determining a runtime frequency of execution of the program statement.

In some embodiments, the method includes: comparing the runtime frequency to a frequency expected by the programmer; and if the runtime frequency mismatches the frequency expected by the programmer, generating a report indicating that the runtime frequency mismatches the frequency expected by the programmer.

In some embodiments, the method includes: determining whether or not to profile the program statement based on the machine-readable comment associated therewith.

In some embodiments, the method includes: detecting entry of the program statement during source code editing; determining that the entered program statement belongs to a group of monitored program statements intended for profiling; and displaying a query to collect the expectation by the programmer of the runtime behavior of the program statement.

In some embodiments, the method includes: selecting the query from a plurality of queries that correspond to a plurality of respective types of monitored statements.

In some embodiments, the method includes: receiving an indication of the expectation by the programmer through a multiple-choice interface.

In some embodiments, the method includes: generating the machine-readable comment based on the received indication of the expectation by the programmer; and inserting the machine-readable comment into the source code at a location associated with the program statement.

In some embodiments, a system for profiling computer programs includes: a monitoring module to profile a program statement associated with a machine-readable comment indicating an expectation by a programmer of a runtime behavior of the program statement.

In some embodiments, the monitoring module is to determine a runtime frequency of execution of the program statement.

In some embodiments, the monitoring module is to compare the runtime frequency to a frequency expected by the programmer, and if the runtime frequency mismatches the frequency expected by the programmer, to generate a report indicating that the runtime frequency mismatches the frequency expected by the programmer.

In some embodiments, the monitoring module is to determine whether or not to profile the program statement based on the machine-readable comment associated therewith.

In some embodiments, the system includes a query manager to detect entry of the program statement during source code editing, to determine that the entered program statement belongs to a group of monitored program statements intended for profiling, and to display a query to collect the expectation by the programmer of the runtime behavior of the program statement.

In some embodiments, the query manager is to select the query from a plurality of queries that correspond to a plurality of respective types of monitored statements.

In some embodiments, the query manager is to receive an indication of the expectation by the programmer through a multiple-choice interface.

In some embodiments, the query manager is to generate the machine-readable comment based on the received indication of the expectation by the programmer, and to insert the machine-readable comment into the source code at a location associated with the program statement.

Some embodiments include, for example, a computer program product including a computer-useable medium including a computer-readable program, wherein the computer-readable program when executed on a computer causes the computer to perform methods in accordance with some embodiments of the invention.

Some embodiments of the invention may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system for profiling computer programs in accordance with a demonstrative embodiment of the invention;

FIG. 2 is a schematic illustration of stages of collection of programmer's expectations input in accordance with a demonstrative embodiment of the invention; and

FIG. 3 is a schematic flow-chart of a method of profiling computer programs in accordance with a demonstrative embodiment of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired and/or wireless links, may utilize one or more components of wireless communication, and may utilize one or more methods or protocols of wireless communication. Some embodiments of the invention may utilize wired communication and/or wireless communication.

The terms “program” “computer program” or “code” as used herein include, for example, a source code, a computer program, a code or program written in a high-level programming language, a code or program written in a very high-level programming language, a code or program written in a low-level programming language, an assembly code or program, a machine language code or program, a single-thread program, a multiple-thread program, a portion of a code or program, a segment of a code or program, one or more instructions or sets of instructions, one or more subroutines, one or more procedures, one or more functions, one or more libraries, a logic, an object-oriented code or program, a portable or non-portable code or program, a code or program that requires compilation by a compiler, an originally-written code or program, a non-optimized code or program, an optimized code or program, a non-modified program, a modified program, a debugged program, a non-debugged program, a pre-compilation program version, a post-compilation program version, a pre-optimization program version, a post-optimization program version, a pre-linking program version, a post-linking program version, a program that was modified manually by a programmer, a program that was modified automatically by a compiler and/or linker and/or debugger and/or optimizer, a program that was subject to one or more iterations of optimization, a program that was subject to one or more methods of optimization, or the like.

The term “statement” as used herein includes, for example, a statement of a computer program, an instruction, a code line, a code portion, a code segment, an expression, a clause, a construct, an operand, an opcode, a string, a set of characters, a portion of a statement, a properly constructed statement, a statement that includes a syntax error or a typing error, a set of consecutive or non-consecutive statements, or the like.

The term “conditional statement” as used herein includes, for example, a construct or code portion that performs an operation (or does not perform an operation) if a condition holds true (or holds false), or vice versa; a construct that performs different computations or different actions depending on whether a programmer-specified condition evaluates to True or False; a construct that selectively modifies the control flow of the program based on a condition; a conditional expression; an if-then construct; an if-then-else construct; a statement utilizing a ternary operator or a conditional expression operator (for example, the statement “variable=(x>5)? 3:4;”); an immediate if (“If”) statement or function; an arithmetic if statement (e.g., in the Fortran 77 programming language); an abstract method in the class Boolean having two subclasses (True and False) and taking two parameters (e.g., in the Smalltalk programming language); a switch statement (e.g., in the C programming language) or a case statement (e.g., in the Pascal programming language); a pattern-matching statement or construct; a branch predication construct that allows conditional execution of instructions; or the like.

The terms “monitored statement” or “profiled statement” as used herein include, for example, a statement which is subject to monitoring and/or profiling and/or matching during the program editing process and/or the program development process and/or during run-time; for example, in some embodiments, a conditional statement.

Although portions of the discussion herein relate, for demonstrative purposes, to monitoring and/or profiling and/or matching of conditional statements, embodiments of the invention may be used for monitoring and/or profiling and/or matching of other types of statements, expressions, code portions, constructs, functions, or the like.

The term “programmer” as used herein includes, for example, a human programmer, a non-human programmer (e.g., a machine or computer able to generate program code automatically or semi-automatically), a set or group of programmers, one or more developers, one or more debugging persons, one or more coders or code writers, or the like.

The term “programmer's expectation(s)” as used herein includes, for example, one or more expectations, estimates, predictions, assumptions, work assumptions, evaluations, anticipations, guesses, hypothesis, conjectures, notions, beliefs, theories, assertions, or forecasts, which a programmer has or may have, for example, with regard to program behavior during run-time, program behavior during execution, program utilization or usage by one or more users, program performance, program flow, or other program properties.

The term “programming language” as used herein may be denoted “PL”. The term “machine-readable” as used herein may be denoted “MR”.

The term “profiling” as used herein includes, for example, one or more operations or functionalities of a profiler; program performance analysis; dynamic program analysis; investigation and/or measurement of a program's behavior using information gathered as the program is executed one or more time; measurement of frequency and/or duration of function calls, statement execution, conditions evaluation, or the like; producing as output a stream or trace of recorded events; producing as output a statistical summary or profile of events observed; measurement of run-time program behavior using data collection, hardware interrupts, code instrumentation, operating system hooks, performance counters, sampling, or the like; locating source code positions corresponding to run-time events; or other suitable operations.

At an overview, some embodiments of the invention allow profiling and matching of portions of computer programs, for example, monitored statements or conditional statements. For example, an a program development tool (e.g., an Integrated Development Environment (IDE)) collects information from a programmer about the programmer's thoughts, expectations and/or assumptions regarding the behavior of the program in run-time, or regarding the utilization of the program by users. The collected expectations are then automatically checked against actual behavior of the program or actual utilization of the program, for example at run-time or on one or more “golden traces” run-time routes. Deviations, or significant deviations, between a programmer's expectation and the actual behavior or usage of the program are identified and reported, and may be used for reviewing the program and for performance enhancements.

Some embodiments thus include a method for collecting information from the programmer about how the programmer expects the program will be used by user(s); as well as an algorithm for validating specific usage scenarios against the programmer's expectation(s). For example, during the program development stage, the programmer utilizes an interface to provide assertions or assumptions about conditional statements in the source code, particularly about the expected frequency of execution of each branch; this information is then matched against profiled frequencies, and disparities are used to mark areas of concern or areas of interest in the program.

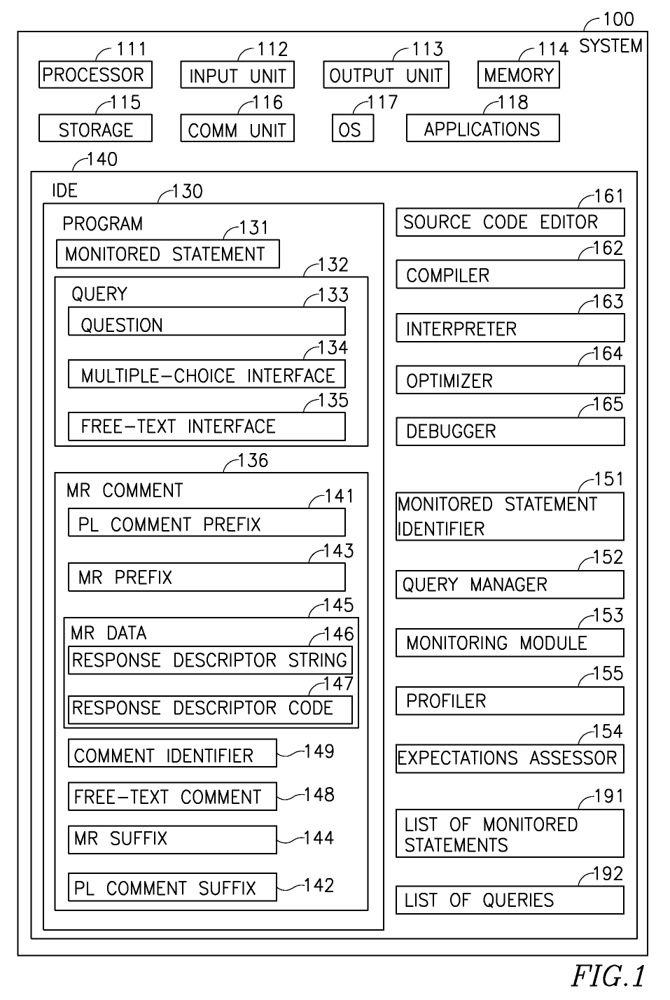

FIG. 1 schematically illustrates a block diagram of a system 100 for profiling computer programs in accordance with some demonstrative embodiments of the invention. System 100 may be or may include, for example, a computing device, a computer, a Personal Computer (PC), a server computer, a client/server system, a mobile computer, a portable computer, a laptop computer, a notebook computer, a tablet computer, a network of multiple inter-connected devices, or the like.

System 100 includes, for example, a processor 111, an input unit 112, an output unit 113, a memory unit 114, a storage unit 115, and a communication unit 116. System 100 may optionally include other suitable hardware components and/or software components.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 executes instructions, for example, of an Operating System (OS) 117 of system 100 or of one or more software applications 118.

Input unit 112 includes, for example, a keyboard, a keypad, a mouse, a touch-pad, a track-ball, a stylus, a microphone, or other suitable pointing device or input device. Output unit 113 includes, for example, a monitor, a screen, a Cathode Ray Tube (CRT) display unit, a Liquid Crystal Display (LCD) display unit, a plasma display unit, one or more audio speakers or earphones, or other suitable output devices.

Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 115 includes, for example, a hard disk drive, a floppy disk drive, a Compact Disk (CD) drive, a CD-ROM drive, a Digital Versatile Disk (DVD) drive, or other suitable removable or non-removable storage units. Memory unit 114 and/or storage unit 115, for example, store data processed by system 100.

Communication unit 116 includes, for example, a wired or wireless Network Interface Card (NIC), a wired or wireless modem, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data. Optionally, communication unit 116 includes, or is associated with, one or more antennas, for example, a dipole antenna, a monopole antenna, an omni-directional antenna, an end fed antenna, a circularly polarized antenna, a micro-strip antenna, a diversity antenna, or the like.

In some embodiments, the components of system 100 may be enclosed in a common housing or packaging, and may be interconnected or operably associated using one or more wired or wireless links. In other embodiments, components of system 100 may be distributed among multiple or separate devices or locations, may be implemented using a client/server configuration, may communicate using remote access methods, or the like.

System 100 includes a program 130, for example, a source code being written or composed by a programmer. Program 130 may include, for example, source code written in a high-level programming language. Program 130 is composed and edited using a development tool, for example, an Integrated Development Environment (IDE) 140 which assists the programmer to develop the program 130. The IDE 140 includes one or more tools, for example, a source code editor 161, a compiler 162 and/or an interpreter 163, an optimizer 164, and a debugger 165. The IDE 140 may include other and/or additional components, for example, automation tools, a version control system, tools to facilitate the construction of a Graphic User Interface (GUI), visual programming tools, or the like.

A programmer utilizes the IDE 140, for example, the source code editor 161, in order to compose, edit or modify the source code of program 130. The programmer types (or otherwise inputs) into the source code of program 130 a monitored statement 131, for example, a conditional statement. Substantially upon completion of entering or typing the monitored statement 131 (e.g., when the programmer uses the “enter” key or the “return” key; or immediately upon typing of the last character required for the conditional statement, e.g., upon typing of the closing bracket for the conditional expression), an identifier module 151 identifies that the programmer entered a monitored statement 131. For example, the identifier module 151 substantially continuously monitors the source code entered by the programmer, and searches for statements or constructs that are similar (or substantially identical) to a list of pre-defined monitored statements 191. For example, the list of pre-defined monitored statements 191 includes “if-then” constructs, “if-then-else” constructs, “case” constructs, “switch” constructs, or the like.

Upon identifying that monitored statement 131 was entered by the programmer, a query manager module 152 is automatically invoked. The query manager 151 selects a query 132 that matches the monitored statement 191, from a pre-defined list of queries 192. For example, a monitored statement 191 of the construct “if expression then statement”, is matched with a query 132 that asks the programmer for an expected frequency that statement is performed; a monitored statement 191 of the construct “if expression then statement1 else statement2”, is matched with a query 132 that asks the programmer for an expected frequency that statement1 is performed and/or an expected frequency that statement2 is performed; a monitored statement 191 of a switch/case construct is matched with a query 132 that asks the programmer for expected frequency of each of the particular cases, and/or for expected frequency of the default case; or the like. In some embodiments, the list of queries 192 may include a single, general query which accommodates multiple types of monitored statements; for example, a query that asks the programmer for an expected frequency that the first (or single) condition will hold true.

The query 132 includes multiple portions, for example, a question 133, a multiple-choice interface 134, and a free-text interface 135. The question 133 includes an inquiry or an interrogative phrase, for example, “What is the expected frequency that this condition will be met?”; or an assertion phrase or request or command, for example, “Please enter the estimated likelihood that this Boolean expression will hold true”.

The multiple-choice interface 134 includes two or more pre-defined answers to the question 133, for example, ranging from a high estimated frequency to a low estimated frequency. The multiple-choice interface 134 may include textual answers, for example, “almost always”, “mostly”, “about even”, “mostly not”, and “almost never”. In some embodiments, the multiple-choice interface 134 may include an answer to indicate that the programmer is not able to provide an estimated frequency or an expectation, for example, “Don't know” or “Not sure”. The multiple-choice interface 134 may optionally include numerical choices or quantifiable choices, for example, “over 90 percent”, “around 50 percent”, “under 25 percent”, or the like. The multiple-choice interface 134 may include a GUI component for efficient selection of an answer by the programmer, for example, a slider allowing the programmer to select an answer from the multiple choices; one or more radio buttons; one or more check-boxes; a drop-down menu; clickable links; selectable graphical items; selectable textual items; or the like.

The free-text interface 135 includes a field in which the programmer is able to type a textual answer to question 133, or to type a textual comment related to question 133, for example, “The condition holds true if the user entered an incorrect password”. The free-text field may be accompanied by an indicator or a title (e.g., “You may enter a free-text comment here:”) to indicate to the programmer or to elicit the programmer to type the comment.

In some embodiments, upon presentation of the query 132, the IDE 140 and/or the query manager 152 may not allow the programmer to continue editing the source code of program 130, unless or until the programmer enters an answer to the query 132, e.g., by selecting an answer to question 133 from the multiple-choice interface 134.

Once the programmer provides an answer to the query 132, the query manager 152 parses the answer, generates a machine-readable comment 136, and inserts or embeds the machine-readable comment 136 into the source code of program 130. The machine-readable comment 136 is inserted at a suitable location, for example, substantially immediately after the monitored statement 131, or within the monitored statement 131.

The machine-readable comment 136 begins with a programming language comment prefix 141 (e.g., the string “/*” in the C programming language), and optionally ends with a programming language comment suffix 142 (e.g., the string “*/” in the C programming language), in order to indicate that the machine-readable comment 136 is a comment in accordance with syntax rules of the programming language of program 130, such that compiler 162 and/or interpreter 163 will disregard the content between the prefix 141 and the suffix 142.

The machine-readable comment 136 further includes, for example, a pre-defined machine-readable prefix 143 (e.g., substantially immediately following the programming language comment prefix 141); as well as a pre-defined machine-readable suffix 144 (e.g., substantially immediately prior to the programming language comment suffix). The machine-readable prefix 143 and suffix 144 indicate to the IDE 140 the location or boundaries of the portion of machine-readable comment 136 relevant for subsequent extraction and/or processing. The pre-defined machine-readable prefix 143 and suffix 144 may be identical (e.g., the string “@@”), or different (e.g., the string “@@!” for machine-readable prefix 143 and the string “!@@” for machine-readable suffix 144).

The machine-readable level 136 further includes, between the machine-readable prefix 143 and suffix 144, machine-readable data 145 indicating the choice that the programmer selected from the multiple-choice interface 134 in response to the question 133. The machine-readable data may include, for example, a machine-readable response descriptor string 146 that corresponds to the programmer's selected response and/or describes (in accordance with pre-defined text) the response selected by the programmer. For example, a response descriptor string 146 may include the string “Programmer's expectation level: Mostly”, or “The estimated frequency that the condition will hold true: Almost never”).

Additionally or alternatively, the machine-readable data 145 may include a machine-readable response descriptor code 147, which may be a relatively short string representing the response descriptor string 146 or corresponding to the response descriptor string 146. For example, a response descriptor string 146 of “Programmer's expectation level: Mostly” may be accompanied by, or replaced with, a response descriptor code 147 of “Code2”; a response descriptor string 146 of “Programmer's expectation level: Almost Never” may be accompanied by, or replaced with, a response descriptor code 147 of “Code5”; or the like. The response descriptor code 147 may optionally include a unique prefix and/or suffix, for example, in a format of “[[Code5]]” or “̂\hat{̂}Choice3̂\hat{̂}” or other suitable formats, in order to distinguish the machine-readable response descriptor code 147 from other portions of the machine-readable comment 136.

The machine-readable comment 136 optionally includes a free-text comment 148, which includes a copy of the comment that the programmer entered using the free-text interface 135 in response to the question 133. Optionally, the free-text comment 148 may be included after a free-text comment identifier 149, for example, a string “Comment:” or “Programmer's comment:”, or the like.

Once the query manager 152 automatically inserts the machine-readable comment 136 into the relevant location of the source code of program 130, the IDE 140 allows the programmer to continue with editing of the source code of program 130. The machine-readable comment 136 may be displayed to the programmer, substantially immediately after its automatic insertion into the source code, for example, using the same color and properties of other statements of the source code, or optionally using a unique color and/or properties (e.g., font properties) to further distinguish the machine-readable comment 136 from other statements of the source code.

In some embodiments, the machine-readable comment may represent the programmer's expectations in various other encoding formats, for subsequent utilization of profiling at program runtime. For example, in some embodiments, the machine-readable comment may be inserted substantially at the end or substantially at the beginning of the program source code, and may include a pointer or reference to the location of the monitored statement 131 (e.g., a reference by line number). Optionally, a machine-readable comment may be constructed to aggregate machine-readable data related to multiple monitored statements 131, and to multiple programmer's expectations corresponding thereto. For example, the machine-readable comment may include the following information: “/* Line 135: Likelihood=4, comment=<invalid input by user>; Line 274: Likelihood=1, comment=<too many users online>*/”. In some embodiments, the machine-readable comment 136, or aggregation of similar machine-readable data 145, may be stored in a separate file (for example, per project, per program 130, per directory, or the like), in a database, in a table, in an XML file, or the like.

In some embodiments, identification of monitored statements 131, and/or insertion of machine-readable comments 136, may not be performed to initial source code entry or to initial composition of source code statements. For example, identification of monitored statements 131, and/or insertion of machine-readable comments 136, may be triggered by subsequent editing or correction of a source code line or portion which includes a conditional statement or other monitored statement 131; or other subsequent modification of the source code such that a monitored statement 131 is created. In some embodiments, identification of monitored statements 131, and/or insertion of machine-readable comments 136, may be performed after the composition of the source code is complete; for example, a previously-composed source code may be scanned or searched for monitored statements 131, and a process of collecting programmer's expectations may be initiated accordingly. In some embodiments, identification of monitored statements 131, and/or insertion of machine-readable comments 136, may be performed in response to a command from the programmer to search for monitored statements 131 and to collect programmer's expectations, for example, with regard to the entire source code or with regard to a user-selected portion of the source code. Other events, conditions or criteria may be used to trigger identification of monitored statements 131 and/or insertion of machine-readable comments 136.

Upon completion of source code editing by the programmer, program 130 is ready for testing and/or real-time execution. Compiler 162 may be adapted to compile the program 130 into an executable program which utilizes the machine-readable comment 136; for example, the compiled code includes a monitoring module 153 to monitor, during run-time, the execution of the monitored statement 131. The monitoring module 153 may, for example, count the number of times in which the monitored statement 131 is executed and its condition holds true, as well as the number of times in which the monitored statement 131 is executed and its condition holds false. Similarly, interpreter 163 may be adapted to include and to utilize monitoring module 153 to collect similar run-time information.

In some embodiments, the monitoring module 153 may be implemented, for example, as an internal part of program 130, as an external part of program 130, as a module or component of IDE 140, as a module or component of system 100, or the like. Optionally, the monitoring module 153 is implemented using a profiler 155 or a profiling module able to profile actual “field conditions” (e.g., and not only test phases) and actual behavior of the program 130. For example, the profiler 155 may be automatically adapted or configured by IDE 140 to profile the monitored statement(s) 131, and/or to selectively profile the monitored statement(s) 131 based on the existence of machine-readable comment(s) 136 associated with the monitored statement(s). For example, IDE 140 may automatically scan the program 130, automatically locate statements having machine-readable comments 136 associated therewith, automatically determine to selectively profile these statements (e.g., monitored statements 131), and automatically configure the profiler 155 to profile the monitored statements 131. Other profiling methods may be used.

The program 130 is executed one or more times, for example, by user(s) other than the programmer, and/or using a representative load. Run-time information is automatically collected by monitoring module 153 regarding the actual performance of the monitored statement 131. An expectations assessment module 154 compares the collected information with the programmer's expectations or estimations as reflected in the machine-readable comment 136. For example, in some embodiments, once the execution of the program 130 is completed, or once a pre-defined number of executions of the program 130 are completed, the expectations assessment module 154 evaluates the actual execution information with respect to the programmer's expectations. In other embodiments, the expectations assessment module 154 may evaluate the actual execution information prior to termination of an entire execution, and it may not be required that the execution of program 130 completely terminates prior to the assessment; for example, assessment of actual execution information with respect to the programmer's expectations may be performed during runtime, or with respect to continuously-running programs or long-running programs (e.g., an Operating System kernel, embedded controllers, or the like).

In some embodiments, for example, the expectations assessment module 154 identifies and reads the machine-readable comment 136, and determines from its content that the programmer expected a condition to hold true “almost never”. This may be translated by the expectations assessment module 154 into an expectation level of “under 10 percent”, for example, using a pre-defined lookup table that converts programmer's expectations into corresponding quantifiable values. The expectations assessment module 154 obtains from the monitoring module 153 the data reflecting the actual behavior or performance of the relevant monitored statement; for example, the run-time data collected by the monitoring module 153 indicates that the condition held true in 84 percent of the times it was evaluated.

The expectations assessment module 154 calculates a difference, a deviation, a disparity, a mismatch or a match between the actual run-time information and the programmer's information, for example, the actual run-time value of 84 percent and the programmer's expectation of under 10 percent. Based on one or more conditions or criteria, the expectations assessment module 154 may determine, for example, whether or not the actual run-time value matches the programmer's expectation, the level of disparity between the actual run-time value and the programmer's expectation, whether or not an alert or notification (e.g., to the programmer and/or the user) is required, and the severity of the alert or notification required.

For example, if the programmer's expectation is that the condition will hold true “almost never” (e.g., translated into “under 10 percent”), and the monitoring module 153 determines that the condition holds true 7 percent of the time, then the expectations assessment module 154 determines that the programmer's expectation matches the run-time behavior. Accordingly, no alert is generated; or alternatively, a positive report is generated to indicate that the programmer's expectation matches the run-time behavior.

For example, if the programmer's expectation is that the condition will hold true “almost never” (e.g., translated into “under 10 percent”), and the monitoring module 153 determines that the condition holds true 12 percent of the time, then the expectations assessment module 154 determines that the programmer's expectation slightly mismatches the run-time behavior. Accordingly, no alert is generated, or a non-severe alert is generated, to the user(s) and/or to the programmer.

In contrast, if the programmer's expectation is that the condition will hold true “almost never” (e.g., translated into “under 10 percent”), and the monitoring module 153 determines that the condition holds true 76 percent of the time, then the expectations assessment module 154 determines that the programmer's expectation significantly mismatches the run-time behavior. Accordingly, a severe alert is generated to the user(s) and/or to the programmer, describing the significant mismatch as well as the relevant monitored statement 191 and its location in program 130.

In some embodiments, the expectations assessment module 154 aggregates data regarding multiple matches and/or mismatches between programmer's expectations and actual run-time program behavior, and optionally reports the aggregated data to the user(s) and/or to the programmer. For example, the expectations assessment module 154 may determine that there are 100 monitored statements 131 in the program 130, corresponding to 65 machine-readable comments 136 reflecting the programmer's expectations; that with regard to 26 of the 100 monitored statements 131, the programmer's expectations match the actual run-time behavior of program 130; that with regard to 33 of the 100 monitored statements 131, the programmer's expectations slightly mismatch the actual run-time behavior of program 130; and that with regard to 41 of the 100 monitored statements 131, the programmer's expectations significantly mismatch the actual run-time behavior of program 130. An aggregated report reflecting this information may thus be generated by the expectations assessment module 154 and provided to the user(s) and/or to the programmer.

Reports, alerts and/or notifications generated by the expectations assessment module 154 may be used, for example, to debug the program 130; to improve or enhance the program 130; to improve or enhance the performance of the program 130; to particularly modify, debug, replace and/or rewrite the monitored statements 131 in which the programmer's expectations significantly deviate from the actual run-time behavior of the program; to assess programming skills of programmers; to assess the professional performance of programmers; to assess the suitability of the program 130 to perform required tasks; to identify code portions where a programmer misunderstood typical program behavior or relied on wrong assumptions; and/or for various other debugging processes, review processes, performance enhancement processes, Quality Assurance (QA) processes, code maintenance processes, code updating processes, code upgrading processes, processes that correlate between Information Technology (IT) resources and business objectives, or the like.

In some embodiments, system 100 automatically (or semi-automatically) collects data from the programmer regarding his expectations of the program 130 behavior; then automatically observes, profiles and measures the actual run-time behavior of the program 130 (for example, by collecting information of observed frequencies of coverage of each branch in conditional statements); automatically assesses the programmer's expectations vis-a-vis the actual run-time behavior; and automatically generates and sends reports, particular reports about a particular monitored statement 131, program-wide reports regarding multiple monitored statements 131, programmer-related reports regarding multiple monitored statements 131 created by a common programmer (e.g., optionally across multiple programs), or the like.

Some embodiments thus provide an automatic or partially-automatic mechanism, optionally implemented using a light-weight machine-readable commenting mechanism, in order to collect programmer's expectations and to measure them against actual run-time behavior. Some embodiments save programming time and/or programming efforts, for example, by automatically generating comments that are machine-readable and/or humanly meaningful, thereby reducing the number of comments that the programmer is required to manually compose.

Although portions of the discussion herein relate, for demonstrative purposes, to a single programmer, embodiments of the invention may be used in conjunction with multiple programmers (e.g., programming in parallel or in series). Optionally, for example, the IDE 140 may present the same query 132 to multiple programmers that take part in programming the program 130; may collect from them multiple responses; and may generate one or more machine-readable comments 136 corresponding to the multiple responses of the multiple programmers. Optionally, system 100 may then monitor and assess the actual run-time behavior of the program 130 in comparison with the separate expectations of each programmer, or in comparison with the average (or otherwise weighted) expectations of the multiple programmers. In some embodiments, the expectations assessment module 154 may generate a report comparing among two or more programmers, for example, indicating that the expectations of a first programmer typically match the actual run-time behavior, whereas the expectations of a second programmer (of the same program, or of another program) typically mismatches the actual run-time behavior. Other statistical analysis may be performed, and other suitable information may be collected, compared and/or computed.

In some embodiments, the IDE 140 may automatically generate other types of queries 132 and/or multiple-choice questions 133, with regard to various types of monitored statements. For example, a function or a subroutine may be a monitored statement; the IDE 140 may ask the programmer for an estimated frequency that the function or subroutine will be called during a typical execution; the collected response may be verified or matched, for example, in comparison to actual program behavior at run-time. Similarly, for example, the IDE 140 may ask the programmer how many clients are estimated to access a shared resource, or are estimated to wait for accessing a shared resource; or how often is an exception expected to be called; or other suitable queries or questions for subsequent profiling and matching.

In some embodiments, optionally, system 100 may profile the code of program 130 without necessarily checking the responses or annotations provided by the programmer; but rather, by analyzing the way or flow in which the code of program 130 is executed.

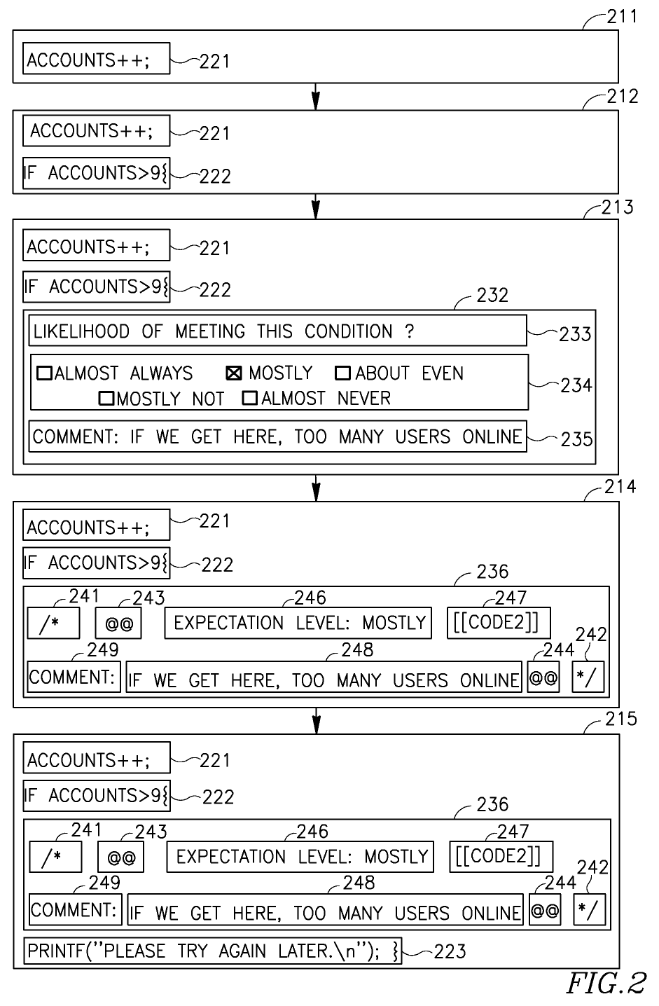

FIG. 2 is a schematic illustration of stages of collection of programmer's expectations input in accordance with some demonstrative embodiments of the invention. Stages 211-215 represent five stages in code development, for example, of a program in the C programming language, using a source code editor (e.g., the IDE 140 of FIG. 1).

As indicated in stage 211, a non-monitored statement 221 is entered by the programmer. In some embodiments, for example, non-monitored 221 is not a conditional statement, and only conditional statements are monitored by the IDE. Accordingly, entering of the non-monitored statement 221 does not trigger presentation of a query, and does not trigger collection of programmer's expectations regarding program behavior.

As indicated in stage 212, a monitored statement 222 is entered by the programmer. Entering the monitored statement (e.g., a conditional statement) by the programmer triggers the presentation of a query for collection of the programmer's expectations regarding program behavior, as indicated further in stage 213.

As indicated in stage 213, following the entering of the monitored statement 222, a query 232 is presented to the programmer. The presented query 232 includes a question 233, a multiple-choice interface 234, and a free-text interface 235. As indicated in code portion 213, in response to the question 233, the programmer selects the second response (“Mostly”) by checking a box in the multiple-choice interface 234; and further enters a free-text comment using the free-text interface 235.

As indicated in stage 214, the presented query 232 is removed or deleted, and is replaced or substituted with a machine-readable comment 236 inserted immediately after the monitored statement 222. The machine-readable comment 236 includes, for example, a programming language comment prefix 241; a machine-readable prefix 243; a response descriptor string 246; a response descriptor 247; a free-text comment identifier 249; a programmer's free-text comment 248; a machine-readable comment suffix 244; and a programming language comment suffix 242.

As indicated in stage 215, a non-monitored statement 223 is entered by the programmer, following the machine-readable comment 236.

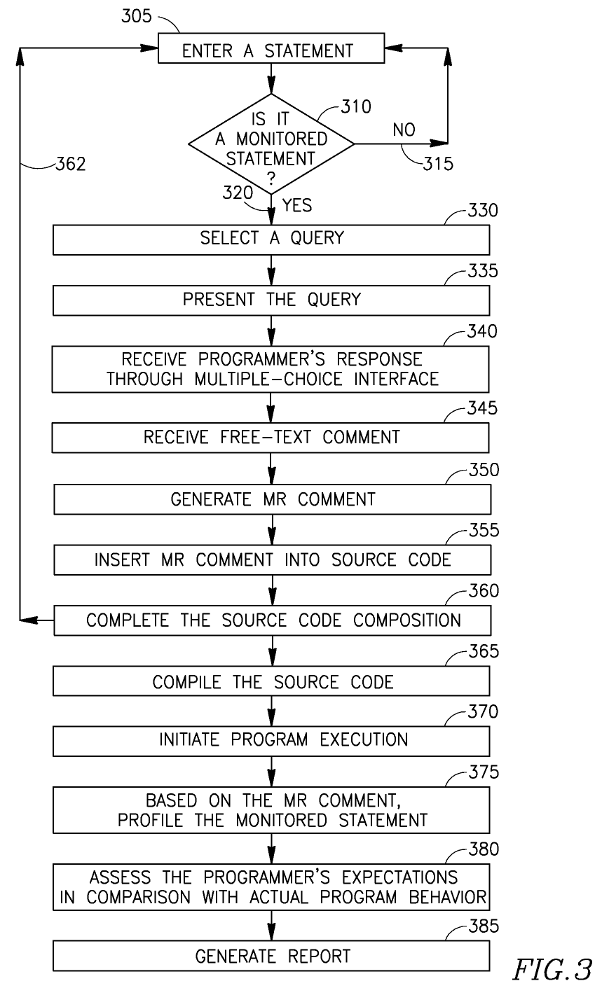

FIG. 3 is a schematic flow-chart of a method of profiling computer programs in accordance with some demonstrative embodiments of the invention. Operations of the method may be used, for example, by system 100 of FIG. 1, by IDE 140 of FIG. 1, and/or by other suitable units, devices and/or systems.

In some embodiments, the method may include, for example, entering a statement into a source code of a computer program (block 305).

In some embodiments, the method may include, for example, checking whether or not the entered statement is of a type of statements being monitored (block 310).

If the entered statement is not of a type of statements being monitored, then the method may proceed with entering another statement (arrow 315).

In contrast, if the entered statement is of a type of statements being monitored, then the method may proceed with the operations of block 330 and onward (arrow 320).

In some embodiments, the method may optionally include, for example, selecting a query corresponding to the entered monitored statement (block 330), for example, from a group of multiple types of queries corresponding to multiple types of monitored statements.

In some embodiments, the method may include, for example, presenting or displaying the query to the programmer (block 335).

In some embodiments, the method may include, for example, receiving the programmer's response to the query using a multiple-choice interface (block 340).

In some embodiments, the method may optionally include, for example, receiving the programmers free-text comment to the query using a free-text interface (block 345).

In some embodiments, the method may include, generating a machine-readable comment representing the programmer's response to the query (block 350).

In some embodiments, the method may include, for example, inserting the machine-readable comment into the source code of the program (block 355), for example, after or within the monitored statement.

In some embodiments, the method may include, for example, completing the composition of the source code of the program (block 360). This may include, for example, repeating the operations of blocks 305 to 355 (namely, entry of additional statements and/or additional monitored statements), as indicated by arrow 362.

In some embodiments, the method may optionally include, for example, compiling the source code into an executable program (block 365).

In some embodiments, the method may include, for example, initiating an execution of the program (block 370).

In some embodiments, the method may include, for example, based on the machine-readable comment, automatically monitoring or measuring or profiling the behavior of the monitored statement during run-time (block 375). This may include, for example, counting the number of times that a conditional statement is accessed and holds true, and/or counting the number of times that a conditional statement is accessed and holds false.

In some embodiments, the method may include, for example, assessing the programmer's expectations of the program behavior in comparison with the actual program behavior as monitored or measured or profiled (block 380). This may include, for example, determining whether the programmer's expectations match, slightly mismatch, or significantly mismatch the program behavior, or vice versa.

In some embodiments, the method may optionally include, for example, generating a report or an alert message conveying the assessed information (block 385).

Other suitable operations or sets of operations may be used; some operations may be repeated for multiple iterations; operations may be performed in other suitable order.

Functions, operations, components and/or features described herein with reference to one or more embodiments, may be combined with, or may be utilized in combination with, one or more other functions, operations, components and/or features described herein with reference to one or more other embodiments, or vice versa.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for profiling computer programs, the method comprising:
profiling a program statement associated with a machine-readable comment indicating an expectation by a programmer of a runtime behavior of the program statement.

2. The method of claim 1, wherein the profiling comprises:
determining a runtime frequency of execution of the program statement.

3. The method of claim 2, comprising:
comparing the runtime frequency to a frequency expected by the programmer; and
if the runtime frequency mismatches the frequency expected by the programmer, generating a report indicating that the runtime frequency mismatches the frequency expected by the programmer.

4. The method of claim 1, comprising:
determining whether or not to profile said program statement based on the machine-readable comment associated therewith.

5. The method of claim 1, comprising:
detecting entry of the program statement during source code editing;
determining that the entered program statement belongs to a group of monitored program statements intended for profiling; and
displaying a query to collect the expectation by the programmer of the runtime behavior of the program statement.

6. The method of claim 5, comprising:
selecting the query from a plurality of queries that correspond to a plurality of respective types of monitored statements.

7. The method of claim 5, comprising:
receiving an indication of the expectation by the programmer through a multiple-choice interface.

8. The method of claim 7, comprising:
generating the machine-readable comment based on the received indication of the expectation by the programmer; and
inserting the machine-readable comment into the source code at a location associated with the program statement.

9. A system for profiling computer programs, the system comprising:
a monitoring module to profile a program statement associated with a machine-readable comment indicating an expectation by a programmer of a runtime behavior of the program statement.

10. The system of claim 9, wherein the monitoring module is to determine a runtime frequency of execution of the program statement.

11. The system of claim 10, wherein the monitoring module is to compare the runtime frequency to a frequency expected by the programmer, and if the runtime frequency mismatches the frequency expected by the programmer, to generate a report indicating that the runtime frequency mismatches the frequency expected by the programmer.

12. The system of claim 9, wherein the monitoring module is to determine whether or not to profile said program statement based on the machine-readable comment associated therewith.

13. The system of claim 9, comprising:
a query manager to detect entry of the program statement during source code editing, to determine that the entered program statement belongs to a group of monitored program statements intended for profiling, and to display a query to collect the expectation by the programmer of the runtime behavior of the program statement.

14. The system of claim 13, wherein the query manager is to select the query from a plurality of queries that correspond to a plurality of respective types of monitored statements.

15. The system of claim 13, wherein the query manager is to receive an indication of the expectation by the programmer through a multiple-choice interface.

16. The system of claim 15, wherein the query manager is to generate the machine-readable comment based on the received indication of the expectation by the programmer, and to insert the machine-readable comment into the source code at a location associated with the program statement.

17. A computer program product comprising a computer useable medium including a computer readable program, wherein the computer readable program when executed on a computer causes the computer to perform a method comprising:
profiling a program statement associated with a machine-readable comment indicating an expectation by a programmer of a runtime behavior of the program statement.

18. The computer program product of claim 17, wherein the profiling comprises:
determining a runtime frequency of execution of the program statement;
comparing the runtime frequency to a frequency expected by the programmer; and
if the runtime frequency mismatches the frequency expected by the programmer, generating a report indicating that the runtime frequency mismatches the frequency expected by the programmer.

19. The computer program product of claim 17, wherein the method comprises:
determining whether or not to profile said program statement based on the machine-readable comment associated therewith.

20. An apparatus for profiling computer programs, the apparatus comprising:
a profiler to profile a program statement associated with a machine-readable comment indicating an expectation by a programmer of a runtime behavior of the program statement,
wherein the profiler is to determine a runtime frequency of execution of the program statement, to compare the runtime frequency to a frequency expected by the programmer,
and if the runtime frequency mismatches the frequency expected by the programmer, to generate a report indicating that the runtime frequency mismatches the frequency expected by the programmer; and
a query manager to detect entry of the program statement during source code editing, to determine that the entered program statement belongs to a group of monitored program statements intended for profiling, to display a query to collect the expectation by the programmer of the runtime behavior of the program statement, and to receive an indication of the expectation by the programmer through a multiple-choice interface.
